(19) United States
(12) Patent Application Publication
(10) Pub. No.: US 2018/0089500 A1
(43) Pub. Date: Mar. 29, 2018

(54) PORTABLE IDENTIFICATION AND DATA DISPLAY DEVICE AND SYSTEM AND METHOD OF USING SAME

(71) Applicant: FST21 Ltd, Rishon Lezion (IL)

(72) Inventors: Ofir FRIEDMAN, Rishon Le-Zion (IL); Shahar BELKIN, KIBBUTZ BRUR CHAYIL (IL)

(73) Assignee: FST21 Ltd, Rishon Lezion (IL)

(21) Appl. No.: 15/563,619

(22) PCT Filed: Mar. 31, 2016
(86) PCT No.: PCT/IL2016/050352

§ 371 Date: Oct. 2, 2017

Related U.S. Application Data
(60) Provisional application No. 62/141,880, filed on Apr. 2, 2015.

(51) Int. Cl. G06K 9/00; G02B 27/01

(52) U.S. Cl. CPC G06K 9/00288; G02B 27/017; G06K 9/00671; G02B 2027/0178; G06K 9/00973; G02B 2027/0138; G02B 2027/014; G06K 9/00892

(57) ABSTRACT

A portable identification device, an identification system and method are disclosed. The device may include a processor, a memory, at least one sensor, and a display unit. The sensor may be at least one of a camera and a directional microphone, and the processor may be configured to: receive from the at least one sensor a data stream, analyze the received data to extract identification data from the received data stream, send at least a portion of the extracted identification data to a remote computing device, receive identity related information from the remote computing device, and present the received identity related information on the display unit.

### FIELD OF THE INVENTION

Embodiments of the present invention relate generally to devices, systems and methods for human and objects identification. More particularly, embodiments of the present invention relate to portable identification devices for obtaining identification data, analyze the obtained data, and present identity related data on a display of the portable device.

### BACKGROUND OF THE INVENTION

In the security of facilities different technologies are used in order to check and verify the identity of people entering the facility, to identify potential threats and to communicate the information to security personnel and access control systems. However, such known technologies are typically intrusive, and require some interaction between the identified person and the system. For example, in most biometric identification systems, a person to be identified is required to pose in front of a camera for a few seconds, or to provide a finger print or an iris print to a scanner. Such systems require stationary equipment and infrastructure in order to efficiently secure a facility.

### SUMMARY OF THE INVENTION

Embodiments of the present invention provide a portable identification device, the device may include a processor, a memory, at least one sensor, and a display unit. According to some embodiments, the at least one sensor may be at least one of a camera and a directional microphone, and the processor may be configured to: receive from the at least one sensor a data stream, analyze the received data to extract identification data from the received data stream, send at least a portion of the extracted identification data to a remote computing device, receive identity related information from the remote computing device, and present the received identity related information on the display unit.

According to some embodiments, the portable identification device may be a handheld mobile device. According to other embodiments, the portable device may be a wearable device.

According to some embodiments, the portable identification device may further include a communication unit configured for wireless communication with a network

The portable identification device according to some embodiments, may further include a direction indicator configured to indicate the direction to which the at least one sensor is directed to, such as a compass.

According to some embodiments, the portable identification device may further include a distance measuring unit, such as, for example, a laser range finder.

The portable identification device according to some embodiments may further comprise a location detection unit, such as a Global Positioning System (GPS).

According to some embodiments, the portable identification device may include a direction indicator, a range finder and a location detection unit.

According to some embodiments, the processor of the portable device may be further configured to: determine the location of the portable device based on input received from the location detection unit, and determine the relative location of at least one object with respect to the determined location of the portable device based on input from the range finder and the direction indicator.

According to some embodiments the portable identification device may further include a power source, such as a battery.

Embodiments of the present invention further provide an identification system, the identification system may include: at least one portable identification device; and at least one server computer. According to some embodiments, the at least one portable identification device may be in active communication with the at least one server computer over a network. In some embodiments, the at least one server computer comprises: a server processor; and a storage.

The at least one portable identification device may include, according to some embodiments: a device processor; a memory; at least one sensor; and a display unit. The device processor may be configured to: receive from the at least one sensor a data stream, analyze the received data to extract identification data from the received data stream, send at least a portion of the extracted identification data to the server processor, receive identity related information from the server computer, and present the received identity related information on the display unit. According to some embodiments, the server processor may be configured to: receive at least a portion of the extracted identification data from the portable identification device; compare the received extracted identification data to pre-obtained and pre-stored identification information, and return to the portable device identity related information based on the comparison.

Embodiments of the present invention further provide a method of identifying an object, the method may include: obtaining by a processor of a portable identification device, inputs, via one or more input devices; analyzing by the processor of the portable device, the inputs received from the one or more input devices, to extract identification data; sending at least a portion of the extracted identification data to a remote computing unit, via a network; receiving by the portable device, identity related information from the remote computing unit; and displaying the identity related information on a display of the portable device.

According to some embodiments, the method may further include comparing, by a remote processor of the remote computing unit, the sent extracted data with pre-stored identification data. According to some embodiments, the method may include sending identity related information to the portable device based on the results of the comparison.

According to some embodiments, the identity related information may be at least one of: a picture of the identified object, identification signs of the identified object, authorizations and permits associated with the identified object.

According to yet another embodiment the method may include determining a location of the portable device, and determining a relative location of an object with respect to the location of the portable device.

Accordingly, there is hereby provided a device, system and method to overcome the longstanding need inherent in the art for providing a portable device for securing a facility and a system and method for using same.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustration of a portable device according to some embodiments of the present invention;

FIG. 2 is a schematic illustration of a wearable portable device according to some embodiments of the present invention;

FIG. 3 is a block diagram of a system according to some embodiments of the present invention; and

FIG. 4 is a flowchart of a method according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

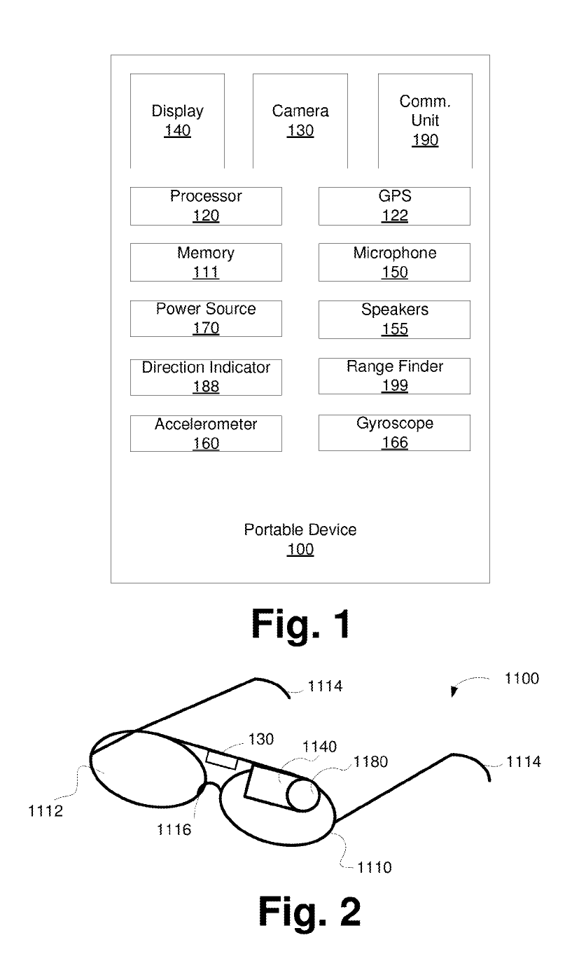

Reference is now made to FIG. 1 which is a schematic block diagram illustration of a portable wireless identification device 100 according to embodiments of the present invention. Portable identification device 100 may be a hand held device, a wearable device or any other portable and mobile device.

Device 100 may comprise processor 120, at least one camera 130, and display 140 such as a monitor, a screen (or a projector 1180 and a transparent display surface, such as prism 1140 in FIG. 2) to display data to a user of device 100. According to some embodiments, camera 130 may be, for example, a video camera, with at least 5 mega pixel resolution and with a lens, or lens system, with an effective field of view of, for example, 30°. It should be appreciated that other types of cameras and lenses may be used. According to some embodiments, display 140 may be a video display and may comprise, for example, a mini display processor.

According to some embodiments, device 100 may further comprise a power source, such as battery 170.

Device 100 may further comprise, according to some embodiments, an audio input device, such as directional microphone 150.

According to some embodiments, device 100 may further comprise spatial position indication unit, such as Global Positioning System (GPS) 122. GPS 122 may be integrated in processor 120 or may be a separate component as illustrated in FIG. 1.

Device 100 may further comprise communication unit 190 for wireless communication with a network such as an internal network, a Local Area Network (LAN), a Wide Area Network (WAN), an enterprise private network or any other computer or wireless communication network known in the art. According to some embodiments of the present invention, device 100 may further comprise memory 111 for storing data collected from input devices, such as camera 130 and microphone 150, or data received from a remote computing device via a network, such as a local network or the internet.

According to some embodiments, device 100 may comprise loud speaker 155. Portable identification device 100 may be designed as a hand held device similar to a cellular phone. It would be appreciated that portable device 100 may be designed in other designs, such as a directional hand held device or a wearable device, as long as it has a display, such as screen 140, that when in use, is visible to the user of device 100.

According to some embodiments, portable identification device 100 may comprise direction indicator 188, such as a compass, to determine the direction to which an input unit of device 100, such as camera 130 and/or microphone 150 is directed. According to additional or alternative embodiments, device 100 may further comprise distance measuring unit 199, such as a laser range finder or any other range finder known in the art.

According to some embodiments, direction indicator 188 and distance measuring unit 199 may allow processor 120 to determine the relative location of an object (e.g. a person entering a secured facility) with respect to device 100. It should be appreciated that when the location of device 100 is known (e.g. through GPS or indoor positioning system) the location of the object in the secured facility or in proximity to the facility may also be calculated by processor 120 (or by a processor of another computing device) based on location, direction and distance information received from indicator 188, distance measuring unit 199 and GPS 122.

According to some embodiments device 100 may further comprise spatial orientation indication units such as accelerometer 160 and/or gyroscope 166. Accelerometer 160 and gyroscope 166 may allow determining by processor 120 the orientation of device 100 and identifying vibrations and motion of device 100.

According to some embodiments, when in use, device 100 may collect data via, for example, one or more of cameras 130, microphone 150 direction indicator 188 and range finder 199, process the collected data by processor 120 to extract the data that is relevant to the identification process, and send the extracted data, by communication unit 190, such as WiFi communication unit, via a network, to a remote computing device, such as a remote server, to compare the data representing identification information received from device 100 to pre-obtained and pre-stored identification information, and return to device 100 identification information and other related information. The returned information may be displayed to the user of device 100, on, for example, prism 1140 (in FIG. 2) or on screen 140 and/or may be presented by audio output device such as speakers or earphones (not shown).

According to some embodiments of the present invention device 100 may comprise a video analytics tool. According to some embodiments, device 100 may further comprise voice analytics tool. It should be appreciated that video analytics tool results and voice analytics tool results may be stored on memory 111.

Video analytics tool may allow video analytics, including, for example, face detection, face crop, color identification and objects counting. The results of video analytics may be sent to the remote server for further processing and for identification of the face in the captured image. The identification information and additional information related to the identification may be sent back to device 100 from the remote server and be presented on display 140 (or projected on prism 1140 by projector 1180, in FIG. 2) of device 100. For example, the additional information may be substantially instantly displayed on display 140, and may include identification information, authorization information, medical information of the identified person, information on authorized individuals that can accompany the authorized person and the like. According to some embodiments the displayed information may include the display of the original enrolment picture of the identified person for local manual identification verification, and the like.

According to some embodiments, voice analytics tool of device 100 may further provide voice analytics, including, for example: Voice Activity Detection (VAD) to identify the presence of human speaking voice and noise cancelation. Voice analytics results may be presented to a user of device 100 (or 1100 in FIG. 2). For example, device 100 and 1100 may send data representing collected voice to the remote server to enable voice verification in the server. The identification information and additional related information may be sent to device 100/1100 from the remote server and be presented on display 140 or 1140 of device 100. Stress in voice analytics detected by the server can also be presented on display 140 or 1140 of device 100 or 1100 respectively.

Video analytics tool, according to some embodiments, may comprise tools for video analytics for licenses plate recognition. Such tools may capture a license plate image; apply an Optical Character Recognition (OCR) tool (by a remote server or by device 100), or by any other character recognition tool known in the art, compare the recognized license plate number to pre-stored license plate numbers of authorized vehicles, and display on display 140, 1140 of device 100, 1100, respectively, relevant information, such as, for example, vehicle entrance authorization information (e.g. the vehicle is allowed to enter the premises or specific areas therein, the vehicle is allowed to park in a specific parking lot in the premises and the like), list of authorized drivers of the vehicle, list and pictures of authorized accompanying individuals and the like.

Video analytics tools, according to some embodiments, may further comprise face or head and shoulders detection tools and heads count tools.

According to some embodiments, the returned identification information may include one or more of the name of the identified person, an image of the identified person, the identified person's authorization to enter the premises or authorization level (i.e. to which areas of the premises the identified person is allowed to enter and from which he is barred) and any other available information about the identified person. For example, when a tenant of a secured building enters the lobby, a guard using a device such as device 100/1100 may obtain an image of the face of the tenant with camera 130 of device 100. Processor 120 may extract identification data from the image and send it to a remote main computing device. The tenant may then be identified as Mr. Smith living at the 4^{th} floor, age 72, owner of a dog called Brenda. Some or all of the above information may be returned to the guard's portable device 100 and may be displayed on, for example, screen 140 (or prism 1140 of FIG. 2). The guard may verify that the person in front of him, in the lobby is a male, over 70. This may add reliability to the identification. The guard can greet Mr. Smith, ask him about Brenda, and may eventually verify that Mr. Smith gets off the elevator at the 4^{th} floor.

Reference is now made to FIG. 2 which is a schematic illustration of a portable identification device, such as device 100 in FIG. 1, designed as a wearable device 1100. Wearable identification device 1100 may comprise a wearable frame 1110 to support and bear the components of device 100 described above with reference to FIG. 1.

Wearable identification device 1100 may be designed as a pair of glasses or sunglasses, having lenses 1112 and ear supports 1114 and nose support 1116. It would be appreciated that wearable device 1100 may be designed in other wearable designs, such as a head strap, a cap or the like, as long as it has a display, such as prism 1140 and a projector 1180 configured to project images to be displayed on prism 1140 or any other display known in the art, that when in use, is visible to the user of device 1100.

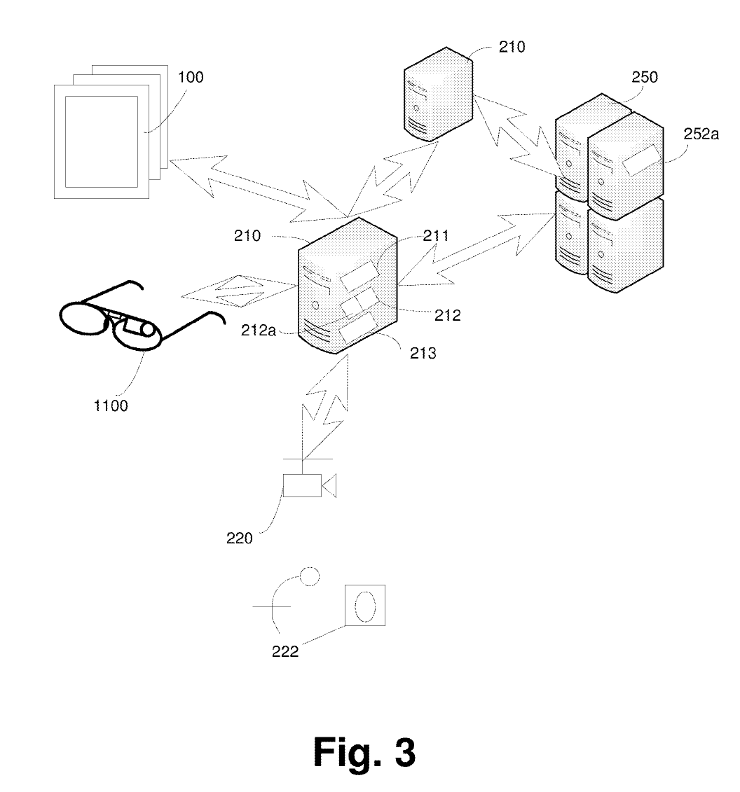

Reference is now made to FIG. 3 which is a block diagram of system 200 according to some embodiments of the present invention. System 200 may comprise one or more identification devices, such as device 100 of FIG. 1 and/or wearable device 1100 of FIG. 2, and a remote computing unit 210. Remote computing unit 210 may comprise processor 211, memory 212, a communication unit 213 to communicate via a network with other computing devices, such as devices 100, 1100 and/or other computing units 210.

According to some embodiments, system 200 may further comprise stationary input devices, such as one or more surveillance cameras 220, and/or other sensors 222 such as audio sensors, infrared sensors, biometric sensors, such as fingerprint scanner, iris scanner and the like, weight sensors and any other sensor known in the art for obtaining identification data.

The term “identification data” may refer to any type of data that may be used in order to identify an object, such as a human, a vehicle, a document and the like.

For example, a security guard may use device 100 to identify people entering a lobby of a secured building. When a person enters the lobby, the security guard may aim device 100 towards that person and look at the person's face, an image of the face may then be captured by camera 130 and processor 120 may extract from the face image data that may be used to identify the person, such as distance between eyes, eye color, and the like, and send the data to remote server 210. Remote server 210 may compare the data received from the device with pre-obtained data of tenants of the secured building, stored in memory 212 and check whether the person in the lobby is one of the tenants. When a positive identification is made (e.g. a tenant having pre-stored data that matches the received identification data), the identity of the person in the lobby may be returned to device 100 and may be presented to the guard on a display of device 100, such as screen 140 or by audio output device such as earphones or speakers 160.

In another example, further to the identification data, the distance of the person in the lobby from the guard may be obtained by range finder 199 and sent together with the identification data, to facilitate the image-based identification of the person.

In yet another example, the direction to which camera 130 is aimed may be determined by direction indicator 188, and the location of the guard may be determined, for example by GPS 122, may be received from external devices (such as surveillance cameras 220 and/or other sensors 222, located in a secured facility, other guards in the facility etc.) or may be known (e.g. the location of the guard booth may be known). In addition, the distance to the examined person may be determined by range finder 199, and the direction to which device 100 is aiming (as may be indicated by direction indicator 188), the location of the guard and the distance to the examined person may be sent to remote computing device 210 and serve in the identification of the examined person, to determine the examined person location in the secured facility and the like.

For example, a guard in a secured facility may be patrolling the facility grounds. The location of the guard during his patrol may be determined, for example, by GPS 122 (in FIG. 1). During the patrol, the guard may come across people, vehicles and other objects that may require identification. The guard may aim device 100 at the object of interest to obtain an image of a person's face, a license plate of a vehicle, an image of a document or a part thereof, and the like, via, for example, camera 130 of device 100 (in FIG. 1) and/or a voice sample via, for example, microphone 150 (in FIG. 1), and may send the identification data to remote computing unit 210. Remote computing unit 210 may analyze the data and determine the identity of the object. For example, when the data received from the guard is a license plate image, a graphical analysis tool of processor 211 of remote computing unit 210 may extract and identify the characters in the license plate image and communicate with database 212a, for example in memory 212, to identify the vehicle. Processor 211 may further extract additional data related to the identified object (e.g. the vehicle). For example, processor 211 may extract from the database 212a in memory 212 vehicle owners' details, vehicle model information, color and pre-obtained information related to the specific vehicle such as images of the vehicle, information regarding accidents, damage to the vehicle and the like. Some or all of the above vehicle identification information may be returned to device 100, 1100 of the guard that sent the initial identification data. According to another example, the identification information together with information relating to the level of authorization of the identified object, such as the identified vehicle in this example, may be sent to the guard. It would be appreciated that the information may also be sent to other or additional guards in the secured premises.

According to another example, when the identified object is a vehicle in motion, the identification information may be sent to guards located in areas in which the vehicle is expected to arrive, based on the direction of movement of the vehicle that may be calculated based on the location of the vehicle in consecutive images obtained by the guard that sent the identification data, the location of the guard (extracted for example from the GPS 122 in FIG. 1), the direction to which device 100 is aimed (from, for example, direction indicator 188 in FIG. 1), and the distance between the guard and the identified object, such as the vehicle of the present example.

According to one embodiment, remote computing unit 210 may be an Identification server, located on the internal network and may be in active communication with device 100.

In an exemplary embodiment, when a person or a plurality of people arrive at secured premises, the guard may look at the one or more persons. Camera (130 in FIG. 1) of device 100, may capture images of the one or more persons and face picture or pictures and may transmit the obtained images, via the local network to the identification server 210, the identification server 210 may compare the received images, such as face images, to a local database 212a of faces and permissions. In one example, if the persons face is recognized, identification server 210 may proceed to compare a received body picture of the person.

According to some embodiments, identification server 210 may send back to portable device 100 the person or persons picture, marked, for example, by an identification label (verified, unidentified, visitor, listed in a black list, etc.) and may further provide information regarding the person, such as, name, his picture from database 212a and special information on this person. All this data is displayed on display (140 in FIG. 1) of device 100, and may be visible only to the guard.

According to some embodiments, the guard may perform a match between the live view of the person in front of him and a picture obtained from database 212a sent to him from remote computing unit, such as identification server 210.

In yet other embodiments of the present invention, when the person arriving at the secured premises is not recognized, or when one or more of the plurality of persons arriving at the premise, are not recognized, but identification server 210 has i optional identified person/s the ID parameters of whom are close or similar, the pictures of the optional identified people may also be sent to device 100. The guard may scroll through the options received at device 100 and displayed on display 140, and if a match is found, the guard may grant or deny access according to additional information presented regarding the identified person.

When there is a need for additional identification data, in order to positively identify the person arriving at the premises, the guard may instruct the person to vocally express, for example, his name and/or password, toward a microphone (150 in FIG. 1) of device 100, device 100 may record the person's voice, send it to remote computing unit 210 such as identification server for verification and receive a visible verification signal to display (140 in FIG. 1).

According to some embodiments of the present invention, when looking, for example, at a car's license plate, camera (130 in FIG. 1) of device 100 may take a picture of the license plate and send it to remote computing unit 210 for OCR by a graphic analysis tool, computing unit 210 may then send a visible signal to display (140 in FIG. 1) that indicates whether the car is authorized or not to enter the premise. It should be appreciated that additional information may be presented, such as, name of optional drivers; information regarding the vehicle in order to allow the guard to verify that the license plate is authentic (e.g. was not replaced or attached to a different car or other vehicle).

In yet another embodiment of the present invention, a guard may use device 100 to add an object, such as a person or a vehicle, to a surveillance list managed by remote computing device 210. For example, when the guard is interested to add a person to surveillance list he may look at the person, and enter a “send command”, for example, by pressing a virtual button on the display of device 100 or by a vocal command.

When an object, such as a person or a vehicle, has been added to a surveillance list, all guards may receive an image of the object to their device 100, 1100. According to some embodiments, the object added to the surveillance list may be added a color analytical print that describes the overall color scheme of the object. A color print, according to embodiments of the present invention, is a number vector that represents the colors of the object in the surveillance list. The color print may be used by processor 120 to create a search in a video stream received from image input device such as camera 130, surveillance camera 220 and the like, for an object, such as a person or a vehicle, that has a similar color print as the searched object.

For example, a color print may be created by identifying a human body (using video analytics); then dividing the body image into, for example, 5 lateral strips of approximately 40 cm each, for each stripe an average color figure may be accorded. The 5 average color figures may then be used to create the color print of the person in the surveillance list.

As may be further seen in FIG. 3, remote computing unit 210 may be in active communication with a central server 250. The communication between remote computing unit 210 and central server 250 may be through any network known in the art, such as the internet.

According to some embodiments, central server 250 may be connected to one or more remote computing units 210. It would be appreciated that when central server 250 is connected to more than one computing unit 210, a central database 252a may be created and stored in central memory 252, to allow sharing information between different locations and different remote computing units 210. It should be further appreciated that this would allow reliance on a single enrolment in order to receive authorization in a plurality of facilities, managed by the same central server 250. Central server 250 may also serve to back up the data from remote computing units 210.

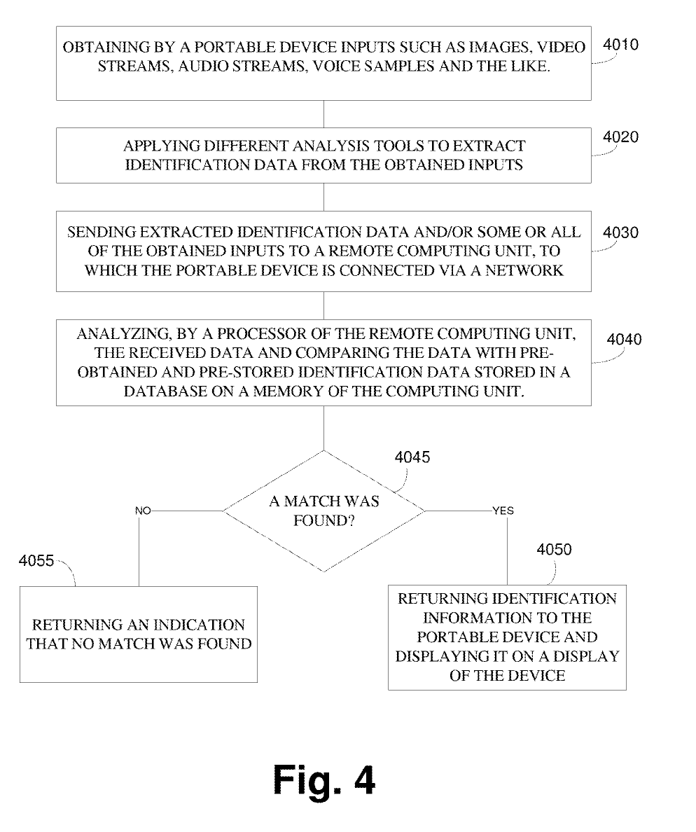

Reference is now made to FIG. 4 which is a flowchart of a method according to embodiments of the present invention. As seen in block 4010, a portable device, such as the device described with reference to FIGS. 1 and 2, may obtain inputs, via one or more of the input devices, such as a camera, a microphone and the like, of the device. The inputs obtained by the device may comprise images, video streams, audio streams, voice samples and the like.

As may be seen in block 4020, according to some embodiments of the present invention, a processor of the portable device may apply different analysis tools to extract identification data from the obtained inputs. For example, an image obtained by the camera of the wearable device may be analyzed by an image analysis tool to extract identification data, such as a face of a person, a distance between the eyes of the person in the image and the like. It should be appreciated that this step may not be required and the analysis of the inputs may be done in its entirety in a remote computing unit, such as remote computing unit 210 in FIG. 3.

The extracted identification data and/or some or all of the obtained inputs may be sent to a remote computing unit, to which the portable device is connected via a network such as a local network or the internet, as may be seen in block 4030.

According to some embodiments of the present invention, in block 4040 a processor in the remote computing unit may further analyze the received data and compare the data with pre-obtained and pre-stored identification data stored in a database on a memory of the computing unit and search for a match (block 4045). For example, the processor of computing unit (210 in FIG. 3) may search in a database (212a in FIG. 3) on memory (212 in FIG. 3) for a record of a person having identification data that is substantially identical to the received identification data. For example, processor (211 in FIG. 3) may compare the extracted distance between the eyes from an image of a person received from device (100, 1100 in FIG. 3) and compare this distance with records in database 212a that have substantially the same distance. Further identification data may be compared with the stored data in order to verify the identity of the person in the image received from the portable device, such as eyes color, face image, hair color etc.).

When a positive identification is reached, for example when there is a single result to the comparison, in block 4050 identification information (as well as additional visual information associated with the identified object) may be returned to the portable device and displayed on a display of the device.

For example, when a positive identification of a person is reached (e.g. a single match has been received between the identification data received from the portable device and the identification data stored in database 212a), remote computing device (210 in FIG. 3) may send to the device 100, 1100 identification information such as, for example, the enrolment picture of the identified person, the name of the person, and additional information that may assist in verifying the person's identity (e.g. unique features in the person's face such as a scar). According to some embodiments, in addition to identification information, or instead of identification information, an indication of authorization to enter the premises or lack of authorization may be send to the device and additional information such as pictures of people that can accompany the identified person. When no match is found, a notice may be sent to the portable device indicating that no match has been found. The notice may be displayed on a display of the device or may be presented to the user in any other way known in the art (block 4055). It should be appreciated by those skilled in the art that other methods may be implemented as described above with respect to FIGS. 1, 2 and 3.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A portable identification device comprising:
a processor;
a memory;
at least one sensor; and
a display unit;
wherein the at least one sensor is at least one of a camera and a directional microphone, and wherein the processor is configured to:
receive from the at least one sensor a data stream,
analyze the received data to extract identification data from the received data stream,
send at least a portion of the extracted identification data to a remote computing device,
receive identity related information from the remote computing device, and
present the received identity related information on the display unit.

2. The portable identification device according to claim 1 wherein the portable device is a handheld mobile device.

3. The portable identification device according to claim 1 wherein the portable device is a wearable device.

4. The portable identification device according to claim 1 further comprising a communication unit configured for wireless communication with a network.

5. The portable identification device according to claim 1 further comprising a direction indicator configured to indicate the direction to which the at least one sensor is directed to.

6. The portable identification device according to claim 1 further comprising a distance measuring unit.

7. The portable identification device according to claim 1 further comprising a location detection unit.

8. The portable identification device according to claim 5 further comprising a range finder and a location detection unit, and wherein the processor is further configured to:
determine the location of the portable device based on input received from the location detection unit, and
determine the relative location of at least one object with respect to the determined location of the portable device based on input from the range finder and the direction indicator.

9. The portable identification device according to claim 1 further comprising a power source.

10. An identification system comprising:
at least one portable identification device; and
at least one server computer;
wherein the at least one portable identification device is in active communication with the at least one server computer over a network, and
wherein the at least one server computer comprises:
a server processor; and
a storage,
wherein the at least one portable identification device comprising:
a device processor;
a memory;
at least one sensor; and
a display unit,
wherein the device processor is configured to:
receive from the at least one sensor a data stream,
analyze the received data to extract identification data from the received data stream,
send at least a portion of the extracted identification data to the server processor, receive identity related information from the server computer, and
present the received identity related information on the display unit, and
wherein the server processor is configured to:
receive at least a portion of the extracted identification data from the portable identification device;
compare the received extracted identification data to pre-obtained and pre-stored identification information, and
return to the portable device identity related information based on the comparison.

11. (canceled)

12. (canceled)

13. The system according to claim 10 wherein the portable identification device further comprises a direction indicator configured to indicate the direction to which the at least one sensor is directed.

14. The system according to claim 10 wherein the portable identification device further comprises a distance measuring unit.

15. The system according to claim 10 wherein the portable identification device further comprises a location detection unit.

16. The system according to claim 13 wherein the portable identification device further comprises a range finder and a location detection unit, and wherein the device processor is further configured to:
determine the location of the portable device based on input received from the location detection unit, and
determine a relative location of at least one object with respect to the determined location of the portable device based on input from the range finder and the direction indicator.

17. The system according to claim 16 wherein the device processor is further configured to send to the server computer the determined location of the device and the relative location of the at least one object.

18. A method of identifying an object, the method comprising:
obtaining by a processor of a portable identification device, inputs, via one or more input devices;
analyzing by the processor of the portable device, the inputs received from the one or more input devices, to extract identification data;
sending at least a portion of the extracted identification data to a remote computing unit, via a network;
receiving by the portable device, identity related information from the remote computing unit; and
displaying the identity related information on a display of the portable device.

19. The method according to claim 18 further comprising comparing, by a remote processor of the remote computing unit, the sent extracted data with pre-stored identification data.

20. The method according to claim 19 further comprising sending identity related information to the portable device based on the results of the comparison.

21. The method according to claim 18 wherein the identity related information is at least one of: a picture of the identified object, identification signs of the identified object, authorizations and permits associated with the identified object.

22. The method according to claim 18 further comprising:
determining a location of the portable device, and
determining a relative location of an object with respect to the location of the portable device.

23. (canceled)

24. (canceled)
